(19) United States
(12) Patent Application Publication
(10) Pub. No.: US 2022/0269274 A1
(43) Pub. Date: Aug. 25, 2022

(54) METHOD FOR FORMING A TRAVELLING PATH FOR A VEHICLE

(71) Applicant: Volvo Truck Corporation, Göteborg (SE)

(72) Inventors: Fabio FORCOLIN, Göteborg (SE); Kinan ALDEBES, Göteborg (SE)

(21) Appl. No.: 17/628,265

(22) PCT Filed: Jul. 31, 2019
(86) PCT No.: PCT/EP2019/070691

§ 371 Date: Jan. 19, 2022

(51) Int. Cl. G05D 1/02; G01S 17/931; G01S 17/89

(52) U.S. Cl. CPC G05D 1/024; G01S 17/931; G01S 17/89; G05D 2201/021; E02F 9/2045

(57) ABSTRACT

The present disclosure relates to a computer implemented method for operating a control system to form a travelling path for a vehicle, where the path determination is based on data generated by a pair of sensors producing three-dimensional (3D) point clouds, where the 3D point clouds respectively provide a representation of a left and a right hand side of the vehicle. The present disclosure also relates to the corresponding control system and to a computer program product.

### TECHNICAL FIELD

The present disclosure relates to a computer implemented method for operating a control system to form a travelling path for a vehicle, where the path determination is based on data generated by a pair of sensors producing three-dimensional (3D) point clouds, where the 3D point clouds respectively provides a representation of a left and a right-hand side of the vehicle. The present disclosure also relates to the corresponding control system and to a computer program product.

### BACKGROUND

Recently there have been great advances in the semi or fully autonomous operation of a vehicle, effectively providing driver assistance and safety functions, such as adaptive cruise control, pedestrian detection, front and rear collision warning, lane departure warning and general obstacle detection. Such an autonomous vehicle typically makes use of a plurality of sensors that are configured to detect information about an environment surrounding the vehicle. The sensor may for example implement camera vision and radar or LiDAR technologies, possibly fusing the outputs form the sensor for forming an understanding of the vehicle environment.

An example of such a vehicle is presented in US20140379247, where the vehicle and its associated control system use information provided from the sensors to navigate through the environment. For example, if the sensor(s) detect that the vehicle is approaching an obstacle, the control system adjusts the directional controls of the vehicle to cause the vehicle to navigate around the obstacle.

Specifically, the control system according to US20140379247 makes use of a navigation/pathing system as well as an obstacle avoidance system for safe navigation of the vehicle within the detected environment surrounding the vehicle, by controlling the speed and direction of the vehicle. Typically, both the navigation/pathing system and the obstacle avoidance system apply a generalized object and feature detection process for navigation and obstacle avoidance, making the operation of the vehicle overall reliable. However, due to the generalized object and feature detection process approach presented by US20140379247, the implementation will typically be computational inefficient and thus slow. Accordingly, it would be desirable to provide further enhancements for improving the path calculation for an autonomous vehicle, specifically targeted towards computational efficiency suitable for an in-vehicle implementation, possibly also allowing for improved robustness of the vehicle operation.

### SUMMARY

According to an aspect of the present disclosure, the above is at least partly alleviated by a computer implemented method for operating a control system to form a travelling path for a vehicle, the control system comprising an electronic control unit (ECU) and a first and a second side facing sensor arranged at the vehicle, the first and a second sensor having a non-overlapping field of view, the ECU arranged in communication with the first and a second sensor, wherein the method comprises the steps of receiving, at the ECU, a first sequence of data from the first sensor and a corresponding second sequence of data from the second sensor, wherein the first and the second sequence of data from the sensors is arranged as three-dimensional (3D) point clouds respectively providing a representation of a left and a right-hand side of the vehicle, correlating, by the ECU, the first and the second sequence of data to form a third sequence of data, the third sequence of data providing a 3D representation of an area between first and the second sensor, selecting, by the ECU, a portion of the third sequence of data representing a traversable area for the vehicle, and forming, by the ECU, the travelling path for the vehicle based on the selected portion of the third sequence of data.

The present disclosure is based upon the realization that it is possible to automatically form a travelling path for a vehicle, even in situations where the data in relation to a forward-facing direction of the vehicle is lacking. Such a situation may for example be manifested by an implementation where no sensor data is available in the forward-facing direction how the vehicle is operated. This in in accordance to the present disclosure achieved by taking into account data from a first and a second sensor being “side mounted” at the vehicle, where the side mounted sensors have a non-overlapping field of view. Specifically, in line with the present disclosure the side mounted sensors are configured to each generate corresponding sequences of data, where the sequences of data from the sensors are provided as 3D point clouds respectively providing a representation of the left and the right-hand side of the vehicle.

The 3D point clouds from the respective sensors are subsequently correlated to form a third sequence of data, the third sequence of data providing a 3D representation of an area between first and the second sensor. Since the 3D point clouds from the respective sensors essentially will relate to objects, such as a wall, a road separator, obstacles, etc. This fact in combination that the sensors are side mounted, i.e. each monitoring an area “away” from the vehicles at the left and right-hand side of the vehicle, makes it possible to identify (in the correlation step) a traversable area for the vehicle. Of course, no information is available in relation what is in front of the vehicles, but as long as the vehicles is able to travel forward this may be seen as an indicator that the area in front of the vehicle in fact is traversable.

Accordingly, if making use of an example where the vehicle is travelling in an enclosed space, such as a road within a mine, then the side mounted sensors will essentially collect information relating to the walls of the mine. By correlating the sensor data, where the sensor data preferably is stored sequentially (chronologically), the mentioned traversable area may be formed. Advantageously, the step of correlating the sensor data comprises comparing a distance between the corresponding data points in the first and the second sequence of data

Thus, in a preferred embodiment of the present disclosure the step of correlating the first and the second sequence of data may also comprise performing a pair wise correlation between data points in the respective sequence of data. Preferably, the traversable area is a surface area, advantageously coinciding with a ground level.

In accordance to the present disclosure, a portion of the third sequence of data is selected. In relation to the above example, e.g. areas close to the respective walls of the mine (or road, obstacles, etc.) may be removed. For example, it may be desirable to not include an area just next to a wall as being absolutely traversable, since e.g. portions of the vehicle potentially could collide with the wall if being to close to the wall. This step may also been seen as a filtering step, where a portion of noise comprised with the 3D point clouds may be filtered out.

Once a portion of the third sequence of data has been selected, it may be possible to use any means for converting the selected portion of the third sequence of data to be a representation of a path that preferably should be selected for travelling of the vehicle. For example, if considering the selected portion of the third sequence of data to be a volume, the travelling path may be seen as a “thinned out” version of the selected portion of the third sequence of data.

In some embodiments of the present disclosure step of forming the travelling path comprises applying an octree processing scheme to the selected portion of the third sequence of data. Such a scheme may also comprise transforming an output from the octree processing scheme for forming a graph, the graph being a representation of the third sequence of data. It may also be advantageous to apply weights to the graph, where data points of the graph arranged closed to an edge of the traversable area is giving a higher weight as compared to data points in a center of the traversable area. Such an implementation may typically provide an improved robustness of the travelling path formation.

Preferably, the sensors for forming the point clouds providing a representation of the surrounding of the vehicle may for example include laser scanner arrangements, radar arrangements, ultrasound arrangements and/or a camera arrangement. Further sensors are of course possible and within the scope of the present disclosure. All of the listed sensor arrangements may allow for the formation of a topology/structure of the area/environment surrounding the vehicle.

In a preferred embodiment the first and a second sensor is a light detection and ranging (LiDAR) sensor. LiDAR sensors calculate the distance between the vehicle and the surrounding surface by emitting a number of lasers. The launch angle of the laser and the distance data are converted into the mentioned three-dimensional (3D) point clouds. The number of points acquired ranges from thousands to hundreds of thousands. Additionally, a scan center for the first and the second sensor is perpendicular to a normal operational direction for the vehicle. As such, the LiDAR sensors are preferably (but not necessarily) arranged to be completely side facing in comparison to a normal operational direction of the vehicle.

In a possible embodiment of the present disclosure, all of the processing must not necessarily be performed onboard the vehicle. Rather, in one possible embodiment of the present disclosure the ECU comprises a first and a second processing portion, the first processing portion is arranged on-board the vehicle and the second processing portion is comprised with a remote server arranged off-board the vehicle, and the method further comprising the step of transmitting the first and the second sequence of data from the vehicle to a remote server, where the steps of correlating, selecting and forming are at least partly performed by the second processing portion.

Accordingly, there is a necessity to collect the sensor data using the sensors arranged on the left and right-hand side of the vehicle, respectively. However, it is then possible but not necessary to form the travelling path onboard the vehicle. Rather, such steps may in some embodiments be allowed to be performed offboard the vehicle, e.g. at a remote server.

According to another aspect of the present disclosure there is provided a control system adapted to form a travelling path for a vehicle, the control system comprising an electronic control unit (ECU) and a first and a second side facing sensor arranged at the vehicle, the first and a second sensor having a non-overlapping field of view, the ECU arranged in communication with the first and a second sensor, wherein the ECU is adapted to receive a first sequence of data from the first sensor and a corresponding second sequence of data from the second sensor, wherein the first and the second sequence of data from the sensors is arranged as three-dimensional (3D) point clouds respectively providing a representation of a left and a right-hand side of the vehicle, correlate the first and the second sequence of data to form a third sequence of data, the third sequence of data providing a 3D representation of an area between first and the second sensor, select a portion of the third sequence of data representing a traversable area for the vehicle, and form the travelling path for the vehicle based on the selected portion of the third sequence of data. This aspect of the present disclosure provides similar advantages as discussed above in relation to the previous aspect of the present disclosure.

In a preferred embodiment of the present disclosure the control system is arranged as a component of the vehicle, where the vehicle advantageously is operated based on the formed travelling path. The vehicle may e.g. be any form of construction equipment, such as e.g. a wheel loader, or any form of “regular” vehicles such as one of a bus, a truck, a car. The vehicle may furthermore be at least one of a pure electrical vehicle (PEV) and a hybrid electric vehicle (HEV). Furthermore, the vehicle may in some embodiments be an autonomously operated vehicle, such as a semi or fully autonomously operated vehicle.

According to a further aspect of the present disclosure there is provided a computer program product comprising a non-transitory computer readable medium having stored thereon computer program means for operating a control system adapted to form a travelling path for a vehicle, the control system comprising an electronic control unit (ECU) and a first and a second side facing sensor arranged at the vehicle, the first and a second sensor having a non-overlapping field of view, the ECU arranged in communication with the first and a second sensor, wherein the computer program product comprises code for receiving, at the ECU, a first sequence of data from the first sensor and a corresponding second sequence of data from the second sensor, wherein the first and the second sequence of data from the sensors is arranged as three-dimensional (3D) point clouds respectively providing a representation of a left and a right hand side of the vehicle, code for correlating, by the ECU, the first and the second sequence of data to form a third sequence of data, the third sequence of data providing a 3D representation of an area between first and the second sensor, code for selecting, by the ECU, a portion of the third sequence of data representing a traversable area for the vehicle, and code for forming, by the ECU, a travelling path for the vehicle based on the selected portion of the third sequence of data. Also this aspect of the present disclosure provides similar advantages as discussed above in relation to the previous aspects of the present disclosure.

The computer readable medium may be any type of memory device, including one of a removable nonvolatile random access memory, a hard disk drive, a floppy disk, a CD-ROM, a DVD-ROM, a USB memory, an SD memory card, or a similar computer readable medium known in the art.

Further advantages and advantageous features of the present disclosure are disclosed in the following description and in the dependent claims.

### BRIEF DESCRIPTION OF THE DRAWINGS

With reference to the appended drawings, below follows a more detailed description of embodiments of the present disclosure cited as examples.

In the drawings:

FIG. 1A illustrates a wheel loader and 1B a truck in which the navigation path determination system according to the present disclosure may be incorporated;

FIG. 2 illustrates a conceptual control system in accordance to a currently preferred embodiment of the present disclosure;

FIGS. 3A-3C exemplifies conversion from point clouds to a travelling path for the vehicle; and

FIG. 4 illustrates the processing steps for performing the method according to the present disclosure.

### DETAILED DESCRIPTION OF EXAMPLE EMBODIMENTS OF THE INVENTION

The present disclosure will now be described more fully hereinafter with reference to the accompanying drawings, in which currently preferred embodiments of the present disclosure are shown. This disclosure may, however, be embodied in many different forms and should not be construed as limited to the embodiments set forth herein; rather, these embodiments are provided for thoroughness and completeness, and fully convey the scope of the disclosure to the skilled addressee. Like reference characters refer to like elements throughout.

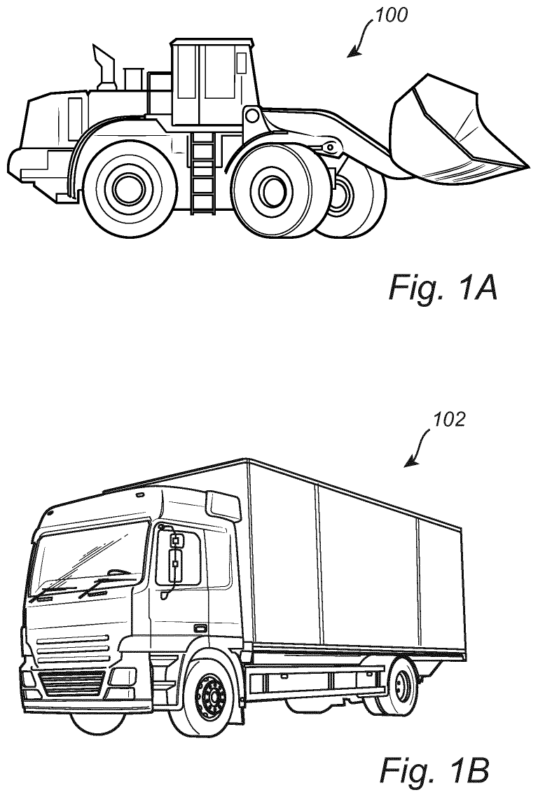

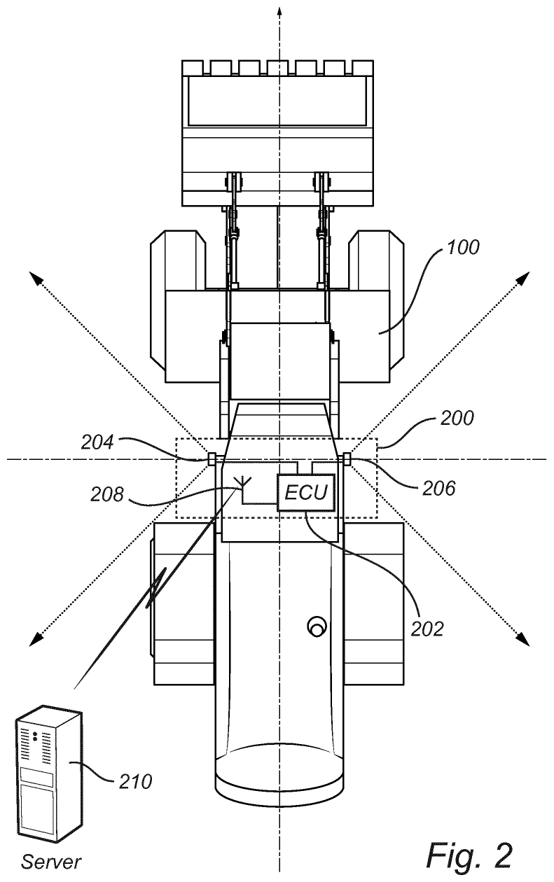

Referring now to the drawings and to FIG. 1A in particular, there is depicted an exemplary vehicle, here illustrated as a wheel loader 100, in which a control system 200 (as shown in FIG. 2) according to the present disclosure may be incorporated. The control system 200 may of course be implemented, possibly in a slightly different way, in a truck 102 as shown in FIG. 1B, a car, a bus, etc. The vehicle may for example be one of an electric or hybrid vehicle, or possibly a gas, gasoline or diesel vehicle. The vehicle comprises an electric machine (in case of being an electric or hybrid vehicle) or an engine (such as an internal combustion engine in case of being a gas, gasoline or diesel vehicle).

FIG. 2 shows a conceptual and exemplary implementation of the control system 200 according to the present disclosure, presented in a non-limiting manner, to e.g. be implemented in the vehicle 100. Other ways of implementing the control system 200 is possible and within the scope of the present disclosure.

As is shown, the control system 200 comprises an electronic control unit (ECU) 202 arranged in communication with a first 204 and a second 206 LiDAR sensor, where the sensors 204, 206 are arranged on the sides of the vehicle 100 (left and right-hand side) and having a non-overlapping field of view.

The ECU 202 may for example be manifested as a general-purpose processor, an application specific processor, a circuit containing processing components, a group of distributed processing components, a group of distributed computers configured for processing, a field programmable gate array (FPGA), etc. The processor may be or include any number of hardware components for conducting data or signal processing or for executing computer code stored in memory. The memory may be one or more devices for storing data and/or computer code for completing or facilitating the various methods described in the present description. The memory may include volatile memory or non-volatile memory. The memory may include database components, object code components, script components, or any other type of information structure for supporting the various activities of the present description. According to an exemplary embodiment, any distributed or local memory device may be utilized with the systems and methods of this description. According to an exemplary embodiment the memory is communicably connected to the processor (e.g., via a circuit or any other wired, wireless, or network connection and includes computer code for executing one or more processes described herein.

The control system 200 may further comprise a transceiver 208, allowing the control system 200 wirelessly communicate with a remote server 210, not forming part of the control system 200. For reference, the transceiver 208 may be arranged to allow for any form of wireless connections like WLAN, CDMA, GSM, GPRS, 3G mobile communications, 3/4/5G mobile communications, or similar. Other present of future wireless communication protocols are possible and within the scope of the present disclosure, such as any form of Vehicle-to-everything (V2X) communication protocols.

Furthermore, the control system 200 may be arranged in communication with one or a plurality of sensors (also not shown) for collecting data relating to the operation of the vehicle 100. Such sensors may for example be configured to collect data relating to a speed of the vehicle 100, an inclination at which the vehicle 100 is currently operate, a sensor for measuring a tire pressure, etc.

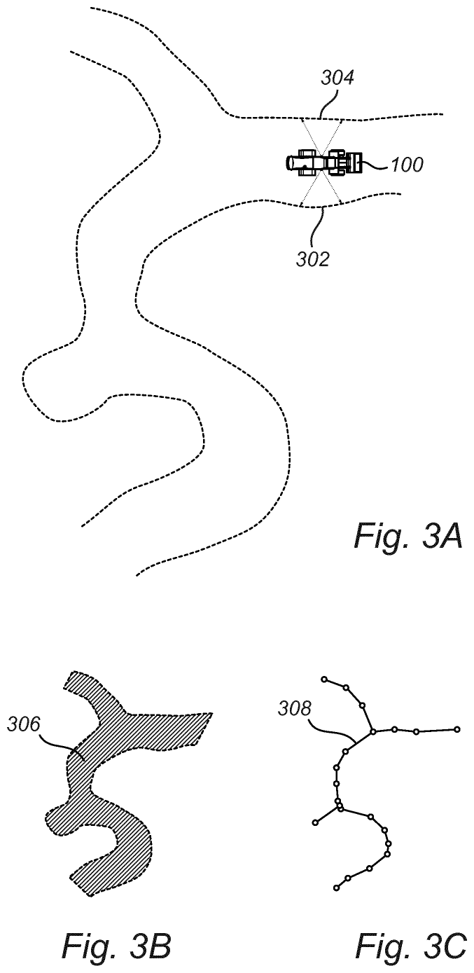

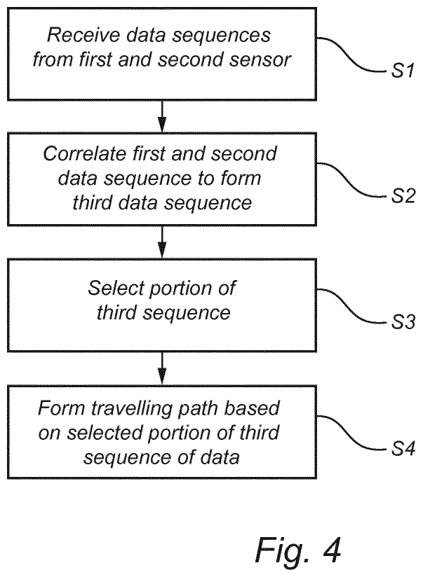

During operation, with further reference to FIGS. 3A-3C and 4, the process starts by receiving, S1, at the ECU 202, a first sequence of data from the first sensor 204 and a corresponding second sequence of data from the second sensor 206, wherein the first and the second sequence of data from the sensors 204, 206 is arranged as three-dimensional (3D) point clouds respectively providing a representation of a left (L) side wall 304 and a right (R) side wall 302 in relation to an operational direction for the vehicle 100.

Thus, in case e.g. the vehicle 100 is travelling in an enclosed space, such as a road within a mine, then the side mounted sensors 204, 206 will essentially chronologically collect information relating to the walls 302, 304 of the mine, such as is specifically shown in FIG. 3A.

Once the information from the sensors 204, 206 has been collected, the chronological information is correlate, S2, by the ECU 202 to form a third sequence of data, the third sequence of data providing a 3D representation of an area between first and the second sensor (204, 206). The correlation is preferably performed by activating a pair wise correlation between data points in the respective sequence of data from the sensors 304, 206. Possibly, the comparison may be seen as determining a distance across the road onto where the vehicle 100 is travelling, such as a distance between the walls 304, 306 of the mine. It may as such be useful to know an internal distance between the sensors 204, 206 when mounted at the vehicle 100. The overall distance between the walls 304, 306 may thus be seen as a sum of the distance measured by the first sensor 206 to the wall 302, plus the distance measured by the second sensor 204 to the wall 304, plus the internal distance between the sensors 204, 206.

Furthermore, a portion of the data in the third sequence of data is subsequently selected, S3, by the ECU 202. This selected portion of the third sequence of data represents a traversable area 306 for the vehicle (100, 102) such as is illustrated in FIG. 3B.

Based on the traversable area 306, it is possible to form S4, by the ECU 202, a travelling path 308, such as shown in FIG. 3C, for the vehicle 100 based on the selected portion of the third sequence of data. The travelling path 306 may for example, in a general case, be seen as a “center” of the traversable area 306. However, to increase the robustness of the scheme it may be possible to apply an octree processing scheme to the selected portion of the third sequence of data. Such a scheme may also comprise transforming an output from the octree processing scheme for forming a graph, the graph being a representation of the third sequence of data. It may also be advantageous to apply weights to the graph, where data points of the graph arranged closed to an edge of the traversable area is giving a higher weight as compared to data points in a center of the traversable area.

The present disclosure contemplates methods, devices and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor.

By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless to a machine, the machine properly views the connection as a machine-readable medium. Thus, any such connection is properly termed a machine-readable medium. Combinations of the above are also included within the scope of machine-readable media.

Machine-executable instructions include, for example, instructions and data that cause a general-purpose computer, special purpose computer, or special purpose processing machines to perform a certain function or group of functions.

Although the figures may show a specific order of method steps, the order of the steps may differ from what is depicted. In addition, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

Additionally, even though the disclosure has been described with reference to specific exemplifying embodiments thereof, many different alterations, modifications and the like will become apparent for those skilled in the art. Variations to the disclosed embodiments can be understood and effected by the skilled addressee in practicing the claimed disclosure, from a study of the drawings, the disclosure, and the appended claims. Furthermore, in the claims, the word “comprising” does not exclude other elements or steps, and the indefinite article “a” or “an” does not exclude a plurality.

1. A computer implemented method for operating a control system to form a travelling path for a vehicle, comprising:
receiving, at an electronic control unit (ECU) of a control system, a first sequence of data from a first side facing sensor of the control system arranged at the vehicle and a corresponding second sequence of data from a second sensor of the control system arranged at the vehicle, the first and second side facing sensor having a non-overlapping field of view, wherein the first and the second sequence of data from the sensors is arranged as three-dimensional point clouds respectively providing a representation of a left and a right hand side of the vehicle,
correlating, by the ECU, the first and the second sequence of data to form a third sequence of data, the third sequence of data providing a 3D representation of an area between the first and second sensors,
selecting, by the ECU, a portion of the third sequence of data representing a traversable area for the vehicle, and
forming, by the ECU, the travelling path for the vehicle based on the selected portion of the third sequence of data.

2. The method of claim 1, wherein the first and second sensors are LiDAR sensors.

3. The method of claim 1, wherein a scan center for the first and second sensors is perpendicular to a normal operational direction for the vehicle.

4. The method of claim 1, wherein correlating the first and the second sequence of data comprises performing a pair wise correlation between data points in the respective sequence of data.

5. The method of claim 1, further comprising:
filtering, by the ECU, the third sequence of data to remove edge data points.

6. The method of claim 1, wherein the first and the second sequence of data represent at least walls of a mine where the vehicle is travelling.

7. The method of claim 1, wherein forming the travelling path comprises applying an octree processing scheme.

8. The method of claim 7, further comprising:
transforming an output from the octree processing scheme to form a graph, the graph being a representation of the third sequence of data.

9. The method of claim 8, further comprising:
applying, by the ECU, weights to the graph, where data points of the graph arranged close to an edge of the traversable area are given a higher weight as compared to data points in a center of the traversable area.

10. The method of claim 1, wherein the traversable area is a surface area.

11. The method of claim 10, wherein the surface area coincides with a ground level.

12. The method of claim 1, wherein correlating the first and the second sequence of data comprises comparing a distance between the corresponding data points in the first and the second sequence of data.

13. The method of claim 1, further comprising:
operating the vehicle based on the formed travelling path.

14. (canceled)

15. A control system adapted to form a travelling path for a vehicle, the control system comprising an electronic control unit (ECU) and a first and a second side facing sensor arranged at the vehicle, the first and second sensors having a non-overlapping field of view, the ECU arranged in communication with the first and second sensors, wherein the ECU is adapted to:
receive a first sequence of data from the first sensor and a corresponding second sequence of data from the second sensor, wherein the first and the second sequence of data from the sensors is arranged as three-dimensional (3D) point clouds respectively providing a representation of a left and a right-hand side of the vehicle,
correlate the first and the second sequence of data to form a third sequence of data, the third sequence of data providing a 3D representation of an area between the first and second sensors,
select a portion of the third sequence of data representing a traversable area for the vehicle, and
form the travelling path for the vehicle based on the selected portion of the third sequence of data.

16. The control system of claim 15, wherein the first and second sensors are LiDAR sensors.

17. The control system of claim 15, wherein a scan center for the first and second sensors is perpendicular to a normal operational direction for the vehicle.

18. The control system of claim 15, wherein correlating the first and the second sequence of data comprises adapting the ECU to perform a pair wise correlation between data points in the respective sequence of data.

19. The control system of claim 15, wherein the ECU is further adapted to:
filter the third sequence of data to remove edge data points.

20. (canceled)

21. The control system of claim 15, wherein forming the travelling path comprises adapting the ECU to apply an octree processing scheme.

22-27. (canceled)

28. The control system of claim 15, wherein the ECU comprises a first and a second processing portion, the first processing portion arranged on-board the vehicle and the second processing portion comprised with a remote server arranged off-board the vehicle, wherein correlate, select and form are at least partly performed by the second processing portion.

29-32. (canceled)
